(19) United States
(12) Patent Application Publication
(10) Pub. No.: US 2009/0125296 A1
(43) Pub. Date: May 14, 2009

(54) METHODS AND SYSTEMS FOR USING DOMAIN SPECIFIC RULES TO IDENTIFY WORDS

(75) Inventors: Wayne C. Imlach, Dublin (IE); Brian P. O'Donnell, Dublin (IE); John P. Halloran, Dublin (IE)

Correspondence Address: PERKINS COIE LLP;PATENT-SEA, P.O. BOX 1247, SEATTLE, WA, 98111-1247, US

(73) Assignee: PopCap Games, Inc.

(21) Appl. No.: 11/937,284

(22) Filed: Nov. 8, 2007

(51) Int. Cl. G06F 17/28

(52) U.S. Cl. 704/9

(57) ABSTRACT

Text entry systems are described that incorporate information from a specific domain to reduce the allowable words that can be spelled by ambiguous user input. The text entry systems can receive an indication identifying a key pressed by a user. The key may represent multiple characters such that the character intended by the user is ambiguous. The text entry systems identify words from a specific domain that can be spelled with any of the multiple characters represented by the key press. The text entry systems then display an indication to the user highlighting the letters of the identified words represented by the key press. Thus, the text entry systems reduce the possible words indicated by the user input based on domain-specific information.

### BACKGROUND

Early text entry systems utilized a full keyboard that contained a letter for each letter of the alphabet. A user entered words by simply pressing the key corresponding to each letter of the word that the user wanted to enter. With the increasing importance of portable devices, a full keyboard is often not available because of its large size. Therefore, mobile devices have relied on alternative text entry methods.

A simple text entry method is multi-tap. In multi-tap methods, the keyboard is typically a three-by four-key keypad containing the numbers 0-9, and the symbols # and *. A portion of the alphabet is typically printed under each key (beginning with the number “2”) in a three-letter sequence as follows: ABC under two key, DEF under three key, and so on. A user enters text by repeatedly pressing the same key to cycle through the letters associated with that key. For example, pressing the three key once would indicate the letter D, twice would indicate the letter E, and three times would indicate the letter F. Pausing for a set period of time will automatically choose the current letter in the cycle, and advance a cursor to allow the user to enter the next letter.

More complex text entry methods attempt to predict the text that the user intends as the user presses keys. For example, T9 (which stands for Text on nine keys) is a predictive text technology for mobile phones, developed by Tegic Communications. T9's objective is to make it easier to type text messages on small mobile devices. T9 allows a user to enter words with a single key press for each letter, as opposed to approaches such as multi-tap. T9 combines the groups of letters found on each phone key with a fast-access dictionary of words. It looks up all the possible words corresponding to the sequence of key presses in the dictionary. The word displayed on the screen is not valid until the whole text is typed. Since T9 tries to find matching words while typing, the suggested word may change after each key press. If T9 displays a word that is not the one the user is looking for, the user can press a NEXT key to scroll through the possible matches. Other predictive text entry methods store common combinations of words and modify what the user is entering when the user has entered two or more words.

Although prediction can improve text entry, current predictive methods are specially suited to traditional uses of text, such as writing sentences in a mobile text message. Thus, current methods assume that the user may be trying to input any word that is in a dictionary used by the method. In addition, current methods may wait for a user to enter a space or punctuation to determine that the user has completed entering a word. As a result, current predictive methods can be time-consuming and input-intensive.

### BRIEF DESCRIPTION OF THE DRAWINGS

FIG. 1 is a block diagram that illustrates components of a text entry system in one embodiment.

FIG. 2 is a block diagram that illustrates an example text entry scenario using a game domain.

FIG. 3 is a flow diagram that illustrates the processing of a domain rules component in one embodiment.

FIGS. 4A-4F are display diagrams that illustrate displays produced by the text entry system in one embodiment.

### DETAILED DESCRIPTION

### Overview

The following disclosure describes a text entry system that incorporates information from a specific domain to reduce the allowable words that can be spelled by ambiguous user input and simplify text entry. Sometimes, a user is entering text in a specific domain in which additional information is available to limit the possible words. However, current text entry methods fail to take advantage of this additional information. In one embodiment, for example, the text entry system receives an indication identifying a key pressed by a user. The key may represent multiple characters such that the character intended by the user is ambiguous. For example, on a typical cell phone in the United States, the number two key represents the letters A, B, and C, the number three key the letters D, E, and F, and so on. When the user presses the number two key, it is ambiguous as to whether the user intends to spell a word with the letter A, B, or C. The text entry system identifies words from a specific domain that can be spelled with any of the multiple characters represented by the key press. For example, if the domain is a game that involves spelling words, then the rules of the game are applied to limit the possible words that the user can spell. The text entry system then displays an indication to the user highlighting the letters of the identified words represented by the key press. For example, if the domain is a game having a game board containing letters, then the text entry system highlights the letters on the game board that are part of the identified words. Thus, the text entry system reduces the possible words indicated by the user input based on domain-specific information.

The following paragraphs describe various elements of the text entry system in further detail.

### System Details

In some embodiments, the text entry system operates in a game domain. For example, one game that uses the text entry system is Bookworm Mobile from PopCap Games. In Bookworm Mobile, a game board contains letter tiles arranged in a layout of rows and columns (e.g., 7×7). Each column is vertically shifted by half the height of a tile from the columns next to it such that any particular letter may be adjacent to up to six other letter tiles if it is in the middle of the game board and fewer if it is at the edges. The letters on the game board are randomly selected, and the object of the game is to spell words by following a path through adjacent letter tiles.

The rules of the game provide additional information that the text entry system uses to narrow the possible words that the user may intend to spell. For example, although some words may be valid according to a dictionary, if there are no adjacent tiles containing the letters of those words, then the words are not allowable words for the game and the text entry system can rule them out.

In some embodiments, the text entry system provides multiple methods of text entry. For example, the text entry system may use a single-tap text entry method as described above by default, but offer a multi-tap text entry method as well. Some users prefer multi-tap text entry, and spelling some words may be easier when the user can explicitly enter each letter. Thus, the text entry system may offer both methods to the user. As another example, the text entry system may offer an onscreen cursor and directional keys that the user can use to navigate around the game board and select a specific letter tile. This text entry method provides information that not only limits the possible words, but also limits the words to a specific location on the game board (e.g., in the instance where the same word could be spelled in two different locations on the game board). In place of cursor keys, the text entry system may also receive similar input from a touch screen. The text entry system may allow the user to switch text entry methods at any time, such that the user could spell some words using one method and other words using another method.

In some embodiments, the text entry system uses the domain rules in conjunction with a dictionary. For example, the text entry system may provide an indication of words that both are found in the dictionary and adhere to the game rules. In this case, the text entry system selects the union of the words in the dictionary and the words adhering to the game rules. Thus, the text entry system provides a potentially narrower list of word options than either the dictionary or the game rules alone provide. Where references are made herein to matching words in a dictionary, those of ordinary skill in the art will recognize that the text entry system is in many instances matching partial words (e.g., the first few characters of a word) to corresponding partial words in the dictionary. Thus, if one permutation of characters based on user-pressed keys is C-H-E, even though these letters alone do not match a word, the text entry system will still match these letters to the word “cheap” in the dictionary, recognizing that the user may enter additional characters. In some embodiments, the text entry system continues to accept characters from the user until a key is pressed to indicate that the user wants to complete the current word.

In some embodiments, the text entry system displays all words that are allowable in the specified domain, but highlights words differently based on whether they are also in the dictionary. For example, Bookworm Mobile shows arrows between possible letter tiles indicated by user input as the user spells a word. If the letters form a word that is in the dictionary, then the arrows are green, and if not, then the arrows are red. In this way, the user can distinguish between sequences of letters that simply correspond to the entered keys and sequences that correspond to valid words.

In some embodiments, the text entry system selects one among several possible words as a currently selected word. Initially, the text entry system may simply select the first word in a list of possible words. For example, if the user has entered three keys that could spell three different words on the game board from left to right, then the text entry system may select the leftmost word. Alternatively, the text entry system may use game rules to select a currently selected word. For example, the game rules may associate a possible score with each word that can be spelled, and the text entry system may automatically select the word with the highest associated score. The text entry system may also receive input to change the currently selected word. For example, many cell phone keypads contain a cursor keypad for moving up, down, left, and right. When the user presses a cursor-moving key, then the text entry system changes the currently selected word to the next possible word in the direction indicated by the cursor key.

### FIGURES

The figures described below illustrate various features of the embodiments of the text entry system described above.

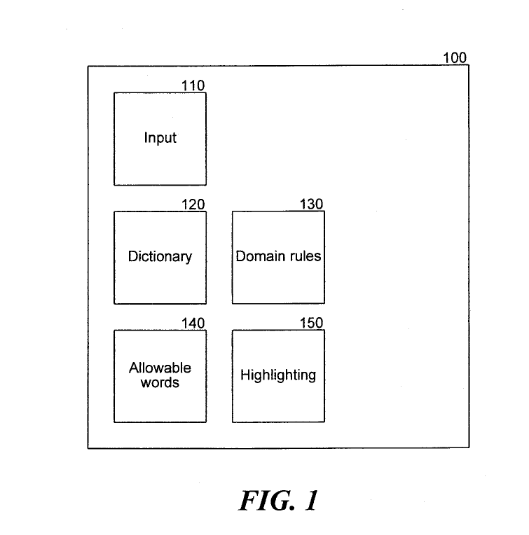

FIG. 1 is a block diagram that illustrates components of a text entry system 100 in one embodiment. The text entry system 100 can include an input component 110, a dictionary component 120, a domain rules component 130, an allowable words component 140, and a highlighting component 150. The input component 110 receives input from a user indicating one or more possible letters that are used to spell a word. For example, the user input component 110 may receive a key press from a telephone keypad that could represent any one of three letters. The dictionary component 120 provides a standard dictionary of words that are valid for a particular language. In some embodiments, the text entry system matches permutations of the letters associated with user key presses to words in the dictionary to determine allowable words. The domain rules component 130 applies domain rules to reduce a list of allowable words that can be formed using the letters associated with user key presses. In some embodiments, the text entry system 100 uses both the dictionary component 120 and the domain rules component 130 to narrow down the list of allowable words. The allowable words component 140 uses the dictionary component 120 and the domain rules component 130 to determine the words that are allowable based on the letters associated with a sequence of user key presses or other input. The highlighting component 150 provides a visual indication to the user displaying allowable words. For example, the highlighting component 150 may highlight letters on a game board or provide a list or other visible indication of allowable words.

The computing device on which the text entry system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the text entry system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the text entry system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The text entry system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

The text entry system may also be implemented in a gambling or casino environment. For example, the system may be part of an automatic gaming machine such as a slot machine or kiosk. The system may award money in place of points or may establish a conversion rate between points and money. The system may also award points based on certain achievements such as finishing a board, spelling a word of a high length, and so forth. In addition, the odds of receiving a monetary award may be adjustable (e.g., by an administrator), such as to comply with governmental gaming regulations related to odds. These adjustments may affect, for example, the likelihood of receiving particular desirable combinations of letters on the game board. Moreover, gaming machines may be networked such that multiple players can interact (e.g., competitively or cooperatively) or share a gaming experience (e.g., a chance to win a pool of money). Those of ordinary skill in the art will recognize that the system can be easily adapted to these and other environments.

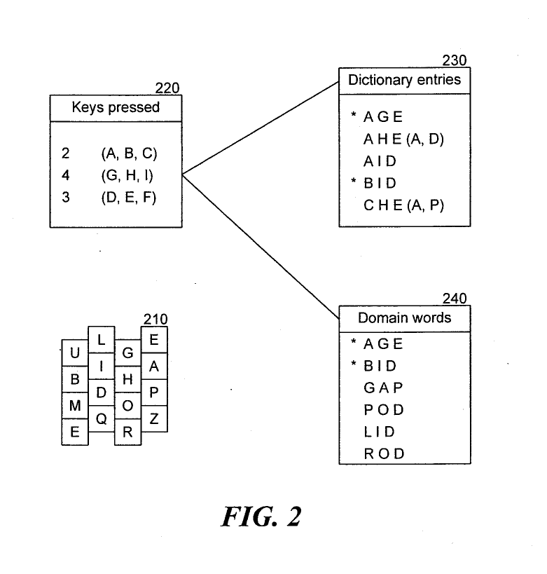

FIG. 2 is a block diagram that illustrates an example text entry scenario using a game domain. The diagram contains a game board 210, a table of keys pressed 220, a table of dictionary entries 230 corresponding to the keys pressed, and a table of domain words 240 corresponding to the keys pressed. The game board 210 contains letter tiles arranged in a layout that a user can use to spell words. The game rules specify that words can only be spelled by starting with a letter on the game board and following with adjacent tiles. The table of domain words 240 contains a list of several words that can be spelled on the game board 210 in accordance with the game rules. The table of keys pressed 220 illustrates the possible intended letters after the user presses a sequence of keys on a numeric keypad (e.g., 2, then 4, then 3). Each key corresponds to three letters, leading to 27 permutations of letters. Of these permutations, only some are valid. The table of dictionary entries 230 indicates the permutations of letters that have corresponding words in the dictionary. Although some permutations do not yet spell words (e.g., CHE), the dictionary indicates that these permutations could spell words if the user enters additional letters (e.g., CHEAP and AHEAD). The union of the words in the table of dictionary entries 230 and the table of domain words 240 contains the words having an asterisk next to them in the diagram (e.g., AGE and BID). Thus, by combining domain-specific information with dictionary information, the text entry system reduces the number of possible words indicated to the user.

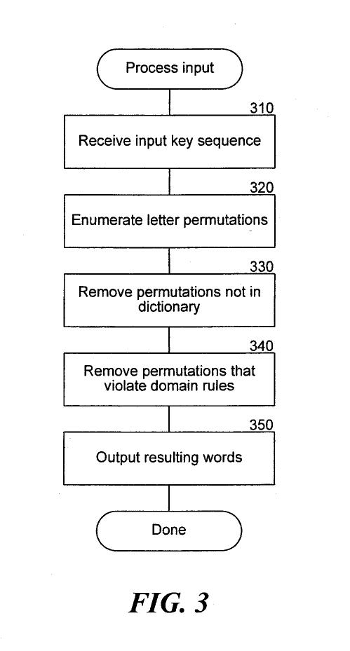

FIG. 3 is a flow diagram that illustrates the processing of the domain rules component in one embodiment. The component is invoked each time the user presses a key associated with one or more letters. In block 310, the component receives an input key and adds the input key to any previously received input keys to form a sequence of key presses. In block 320, the component enumerates the permutations of letters based on the input key sequence to form a list of possible words. In block 330, the component removes from the list any permutations that are not in a dictionary of valid words. In block 340, the component removes from the list any remaining permutations that are not valid according to the current domain rules. For example, the domain may specify which letters can follow one another. In block 350, the component outputs the permutations remaining on the list as a list of allowable words. After block 350, these steps conclude.

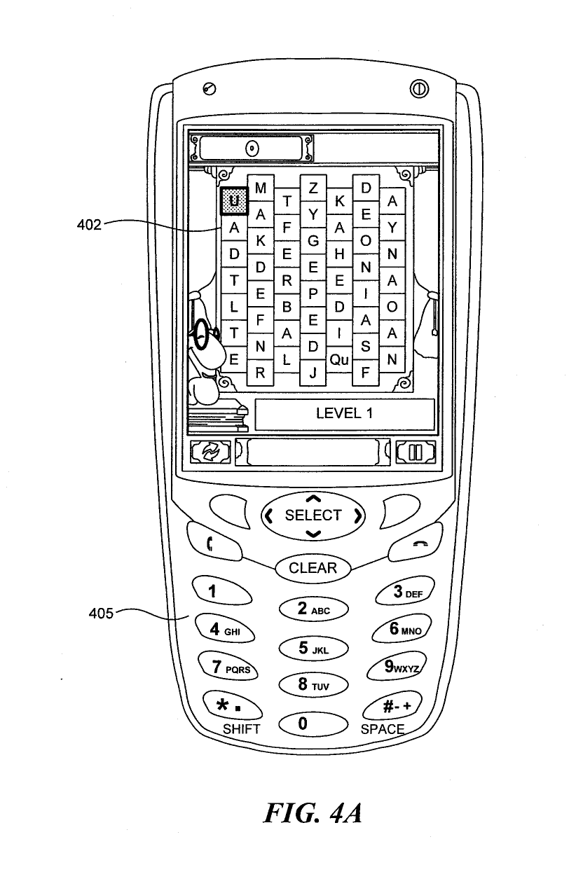

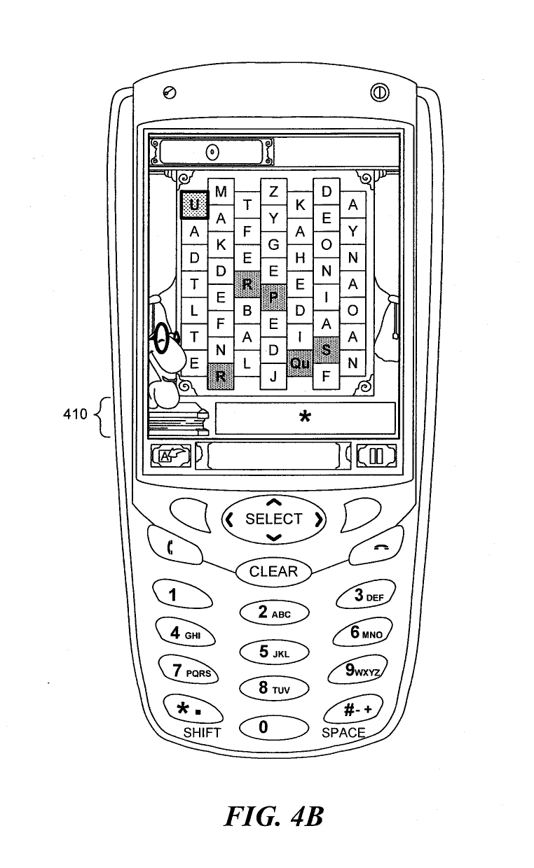

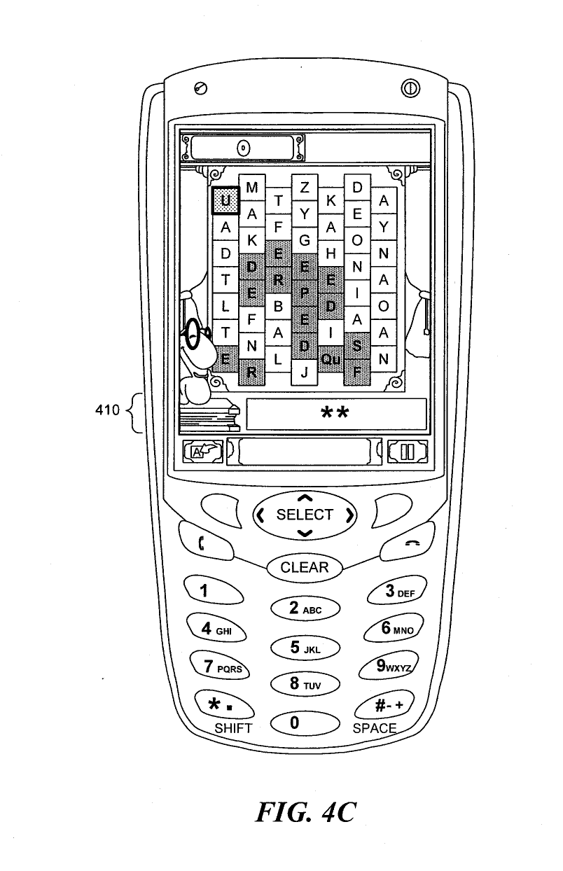

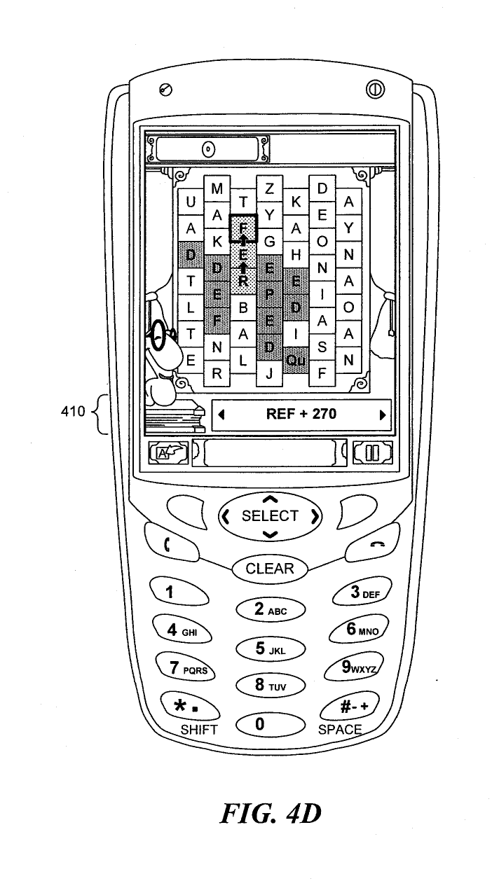

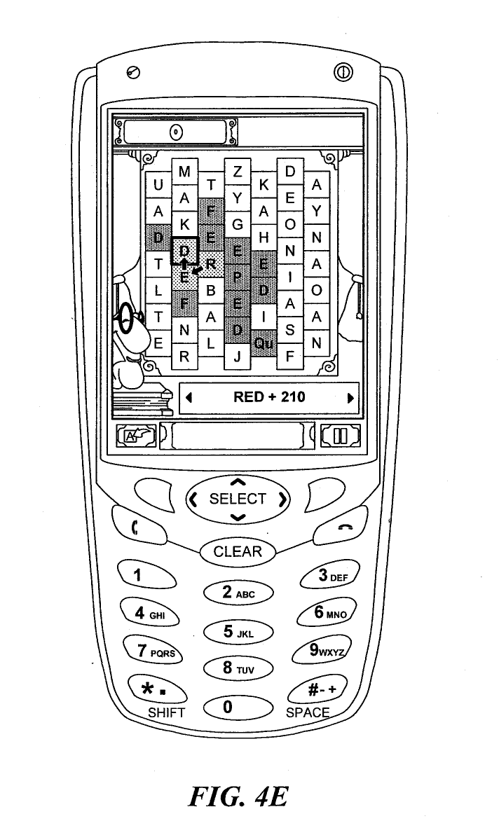

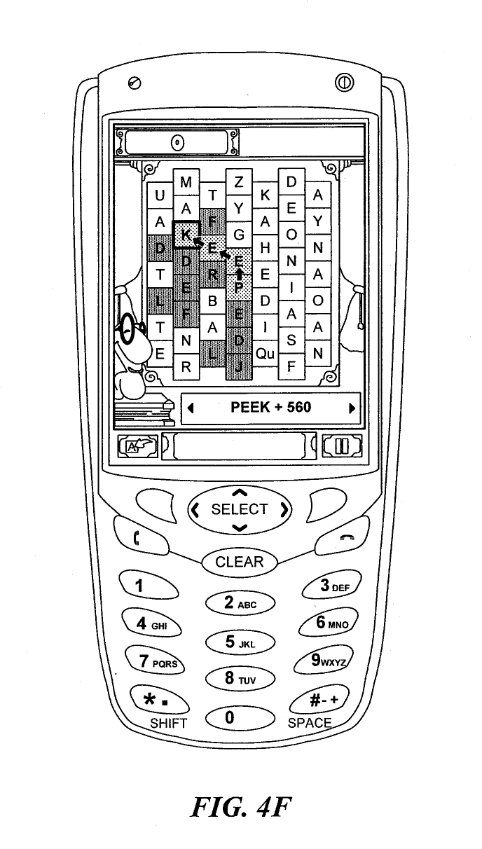

FIGS. 4A-4F are display diagrams that illustrate displays produced by the text entry system in one embodiment. The domain in these figures is the game Bookworm Mobile. FIG. 4A illustrates an example of a randomly generated game board 402 with a default phone keypad layout 405. The game board 402 contains rows and columns of tiles. The game rules specify that a user can spell words using adjacent tiles. Initially, a cursor highlights the top leftmost letter (e.g., U in this case). FIG. 4B illustrates the game board after the user has pressed the seven key. The seven key on the keypad is associated with the letters P, Q, R, and S. Each P, Q, R, and S on the game board is highlighted with a soft white highlight. A spelled word area 410 indicates with a single asterisk that the user has entered one letter. FIG. 4C illustrates the game board after the user has pressed the three key. The three key is associated with the letters D, E, and F. The text entry system has highlighted each location on the screen where the letters P, Q, R, and S from the first key press are adjacent to the letters D, E, and F from the second key press. The spelled word area 410 now contains two asterisks to indicate that the user has entered two letters.

FIG. 4D illustrates the game board after the user has pressed the three key a second time. The text entry system now highlights the appropriate three-letter permutations on the game board. The game rules specify a three-letter minimum for spelling words (e.g., the words IT and A are not allowable). Now that the user has entered three letters, the spelled word area 410 contains the word on the game board (e.g., REF) associated with the highest number of points (e.g., 270). Note that there are other possible words, such as FED and PEE, but these words are not the currently selected word. The currently selected word is displayed in a bolder highlight with arrows between the letters. FIG. 4E illustrates the game board after the user has pressed an arrow key to change the currently selected word to RED.

FIG. 4F illustrates the game board after the user has pressed the five key, adding a fourth letter to the sequence. The currently selected word changes to PEEK, which is highlighted with a bold highlight. In the displayed embodiment, the key sequence is not compared to a dictionary of valid words, so every sequence of four letters on the game board that matches the key sequence is also highlighted using a soft highlight. The game does not use a dictionary to reduce the words because displaying only valid words could give the user too much of a scoring advantage or make it difficult to see longer words that could be spelled if the user presses additional keys. When the user is satisfied with the currently selected word, the user presses a key to submit the word and the game awards the user the specified number of points.

### CONCLUSION

From the foregoing, it will be appreciated that specific embodiments of the text entry system have been described herein for purposes of illustration, but that various modifications may be made without deviating from the spirit and scope of the invention. For example, although the game domain has been described, many other domains that can limit the possible words a user is entering can use similar methods. For example, in some environments the possible words may be limited to medical or legal terminology. In addition, although mobile devices have been described, the above methods can be used with any type of device or in any situation in which a user enters text without indicating an explicit input for each letter. Accordingly, the invention is not limited except as by the appended claims.

I/We claim:

1. A method of entering text on a user input array having multiple selectors, the method comprising:
receiving an indication identifying at least one selector from a user, the selector representing multiple text characters such that the character intended by the user is ambiguous;
identifying words on a game board that can be spelled with any of the multiple characters represented by the identified selector; and
displaying an indication to the user of the identified words on the game board that can be spelled with any of the multiple characters represented by the identified selector.

2. The method of claim 1 wherein the selector also represents at least one number or other non-character symbol.

3. The method of claim 1 including identifying one identified word as the currently selected word, and displaying a stronger highlight indication to the user for the currently selected word.

4. The method of claim 1 including identifying one word as the currently selected word and upon receiving an indication from the user to select another word as the currently selected word, selecting another identified word as the currently selected word.

5. The method of claim 1 wherein the game board contains letters arranged according to a layout, and wherein identifying words comprises identifying words that can be spelled with adjacent letters in the layout.

6. The method of claim 1 wherein the selector is a number key on a mobile phone keypad.

7. The method of claim 1 including receiving an indication that the user wants to switch to a multi-tap method of text entry, and receiving an indication identifying a letter entered by the user using the multi-tap method.

8. The method of claim 1 wherein the selector is associated with three or four letters.

9. A computer-readable storage medium encoded with instructions for controlling a computer system to identify words based on a limited dictionary, by a method comprising:
receiving a series of key presses, each key press representing multiple characters such that the character intended by the user for each key press is ambiguous;
creating a list of possible words that can be spelled by the permutations of characters represented by the series of key presses; and
reducing the list of possible words based on domain specific rules that limit the allowable permutations.

10. The computer-readable medium of claim 9 wherein the domain specific rules comprise rules of a game involving spelling words.

11. The computer-readable medium of claim 9 wherein creating the list of possible words comprises looking up the permutations of characters in a dictionary.

12. The computer-readable medium of claim 9 wherein creating the list of possible words comprises identifying words that begin with the permutations of characters.

13. The computer-readable medium of claim 9 including, when reducing the list of possible words results in an empty list, providing an error indication to the user.

14. The computer-readable medium of claim 9 including, as each key is entered, updating the list of possible words.

15. The computer-readable medium of claim 9 including identifying a currently selected word in the list of possible words.

16. The computer-readable medium of claim 9 including displaying an indication of the words in the list of possible words on a display device.

17. A system for identifying words spelled by a user based on multi-letter input, the system comprising:
a user input component configured to receive a multi-letter input indication, wherein the multi-letter input comprises a single action from the user that can represent more than one letter;
a dictionary component configured to determine words spelled by the received multi-letter input based on a dictionary of words; and
a domain rule component configured to apply domain-specific rules to limit the allowable words spelled by the received multi-letter input, wherein the allowable words comprise the union of words allowed by both the dictionary and the domain-specific rules.

18. The system of claim 17 including a highlighting component configured to provide a visible indication to the user of the allowable words.

19. The system of claim 17 wherein the game rule component applies the rules of a game that involves spelling words.

20. The system of claim 17 wherein the user input component comprises a multi-key phone keypad.
